(19) United States
(12) Patent Application Publication
(10) Pub. No.: US 2014/0201949 A1
(43) Pub. Date: Jul. 24, 2014

(54) OFFSET HINGE

(71) Applicant: JOHN THADDEUS MORRIS, HOUSTON, TX (US)

(72) Inventor: JOHN THADDEUS MORRIS, HOUSTON, TX (US)

(21) Appl. No.: 14/105,661

(22) Filed: Dec. 13, 2013

Related U.S. Application Data
(63) Continuation-in-part of application No. 13/747,374, filed on Jan. 22, 2013, now abandoned.

(51) Int. Cl. E05D 7/00

(52) U.S. Cl. CPC E05D 7/00
USPC 16/387

(57) ABSTRACT

An offset hinge is configured to arrange a side plate and a bottom plate. The offset hinge has a first portion swingably coupled to a second portion with a pin and knuckle connector. Both portions have a parallel section immediately adjacent to a perpendicular section such that the parallel sections can be mechanically coupled to the plate plates while the perpendicular sections and the pin and knuckle connector further support the plates in place. The first perpendicular section has a non-collinear arrangement with the second perpendicular section such that the first perpendicular section and the second perpendicular section are both offset from a center of the pin in the pin and knuckle connector.

### CROSS REFERENCE TO RELATED APPLICATIONS

This application is a continuation in part of U.S. patent application Ser. No. 13/747,374 filed on Jan. 22, 2013 which is presently pending and, in turn, claims priority to U.S. Provisional Patent Application 61/593,212 filed on Jan. 31, 2012.

### FIELD OF THE INVENTION

This invention relates to devices that swingably connect two members.

### BACKGROUND OF THE INVENTION

Prior to the disclosed invention, hinges failed to adequately displace weight and steadily hold the two members. Embodiments of the present invention solves this problem.

### BRIEF SUMMARY OF THE INVENTION

An offset hinge is configured to arrange a side plate and a bottom plate. The offset hinge has a first portion swingably coupled to a second portion with a pin and knuckle connector. The first portion further comprises a first parallel section immediately adjacent to a first perpendicular section such that the first parallel section can be mechanically coupled to a top surface of the side plate which the first perpendicular section and the pin and knuckle connector further support the side plate and hold the side plate in place. The second portion further comprises a second parallel section immediately adjacent to a second perpendicular section such that the second parallel section can be mechanically coupled to a bottom surface of the bottom plate which the second perpendicular section and the pin and knuckle connector further support the bottom plate and hold the bottom plate in place. The first perpendicular section has a non-collinear arrangement with the second perpendicular section such that the first perpendicular section and the second perpendicular section are both offset from a center of the pin in the pin and knuckle connector.

In some embodiments, the first perpendicular section further comprises a knuckle connector first portion. The second perpendicular section further comprises a knuckle connector second portion. The pin is inserted through the knuckle connector first portion and the knuckle connector second portion to form the pin and knuckle connector. In some embodiments, the first perpendicular section can larger than the second perpendicular section to accommodate the side plate that is thicker than the bottom plate.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a perspective view of the invention shown in non-collapsed configuration.

FIG. 2 is a perspective view of an embodiment of the invention shown in collapsed configuration.

FIG. 3 is a top view of an embodiment of the invention.

FIG. 4 is a side view of an embodiment of the invention shown in non-collapsed configuration.

FIG. 5 is a side view of an embodiment of the invention shown in collapsed configuration.

FIG. 6 is a perspective view of an embodiment of the offset hinge.

FIG. 7 is a top view of an embodiment of the offset hinge.

FIG. 8 is a section view of an embodiment of the offset hinge along line 8-8 in FIG. 7.

FIG. 9 is a section view of an embodiment of the offset hinge along line 9-9 in FIG. 7.

### DETAILED DESCRIPTION OF THE INVENTION

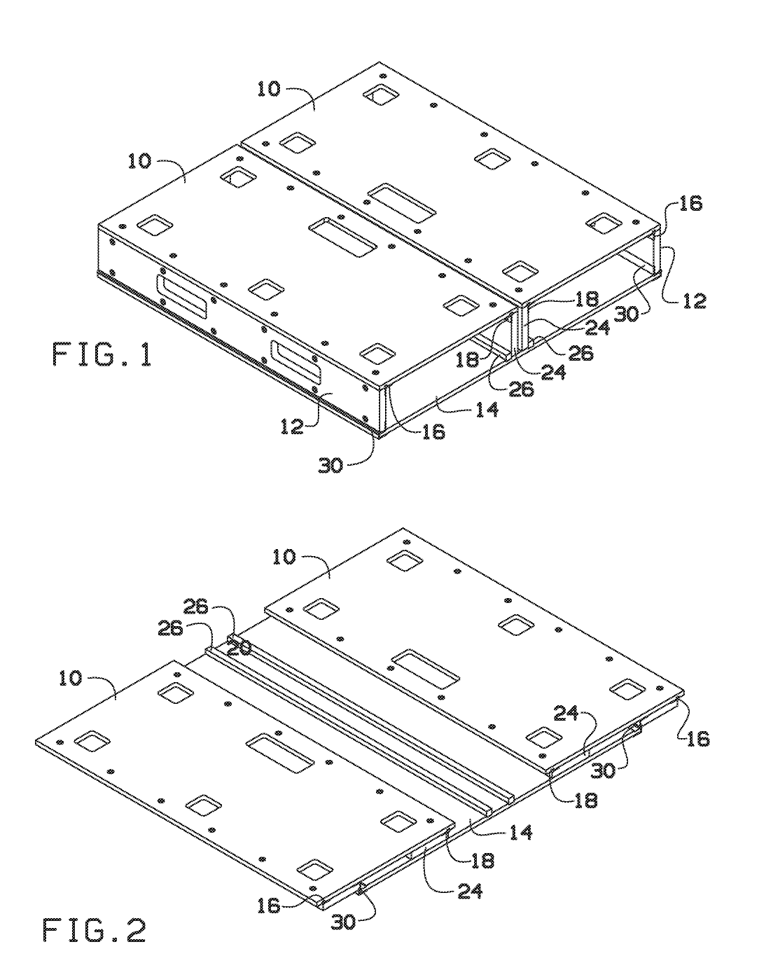

Turning first to a use for offset hinge 30, FIG. 1 and FIG. 4 show an embodiment of the invention in a non-collapsed configuration. Bottom plate 14 is mechanically coupled to left side plate 12 by left offset hinge 30. Left side plate 12 is further mechanically coupled to left upper plate 10 by left outer piano hinge 16. Left upper plate 10 is mechanically coupled to left inner support plate 24 by left inner piano hinge 18. Left inner support plate 24 is shown with a bottom side immediately adjacent to bottom plate 14. The movement of left inner support plate 24 is restricted by left stopper strip 26, which is mechanically coupled to bottom plate 14.

In a similar manner, bottom plate 14 is mechanically coupled to right side plate 12 by right offset hinge 30. Right side plate 12 is further mechanically coupled to right upper plate 10 by right outer piano hinge 16. Right upper plate 10 is mechanically coupled to right inner support plate 24 by right inner piano hinge 18. Right inner support plate 24 is shown with a bottom side immediately adjacent to bottom plate 14. The movement of right inner support plate 24 is restricted by right stopper strip 26, which is mechanically coupled to bottom plate 14.

One of the unique features of the present invention is offset hinge 30. Offset hinge 30 comprises a first parallel surface mechanically coupled to a first perpendicular surface. The first perpendicular surface is mechanically coupled to a rod. The rod mechanically couples the first perpendicular surface with a second parallel surface. The second parallel surface is mechanically coupled to a second parallel surface. In this manner,

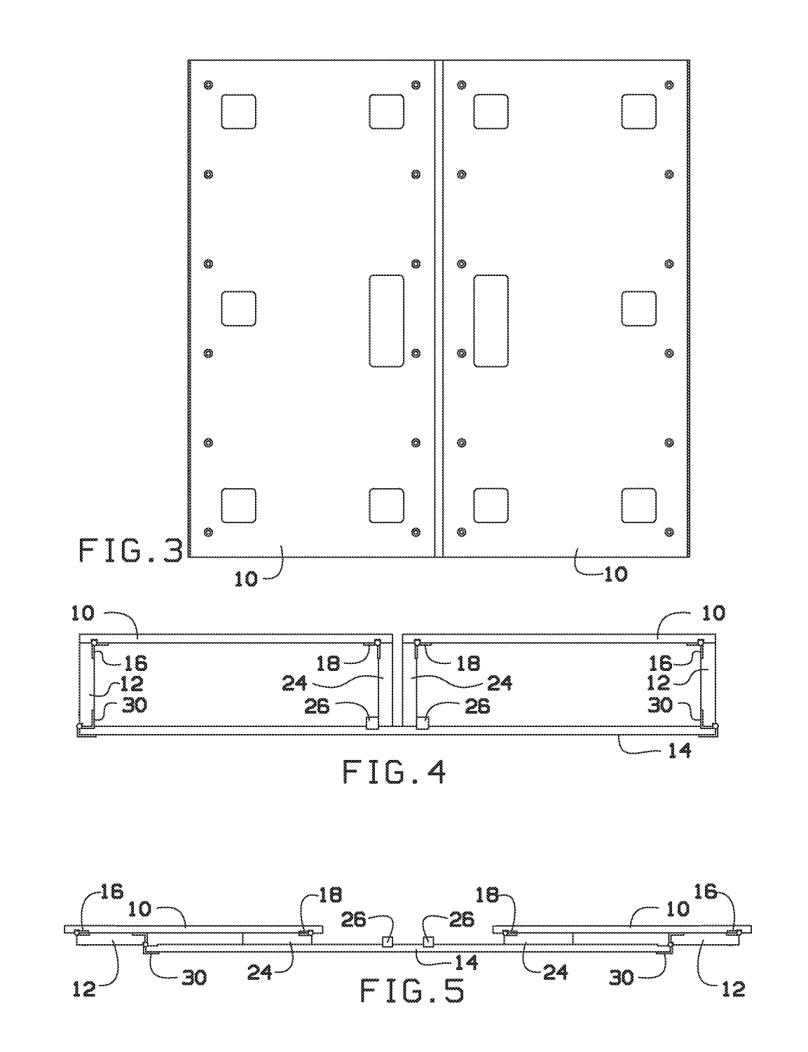

FIG. 1 and FIG. 3 show the location of a plurality of cavities in upper plate 10 and side plate 12. The cavities provide positioning for easy net and strap attachment to ship a wide variety of goods.

Following the teaching in this application will enable a user to ship more than twice as many pallets in a standard sized truck from a receiver to a shipper because of the compact nature of the collapsible pallet in the collapsed configuration. In this matter the collapsible pallet provides for easy storing and shipping.

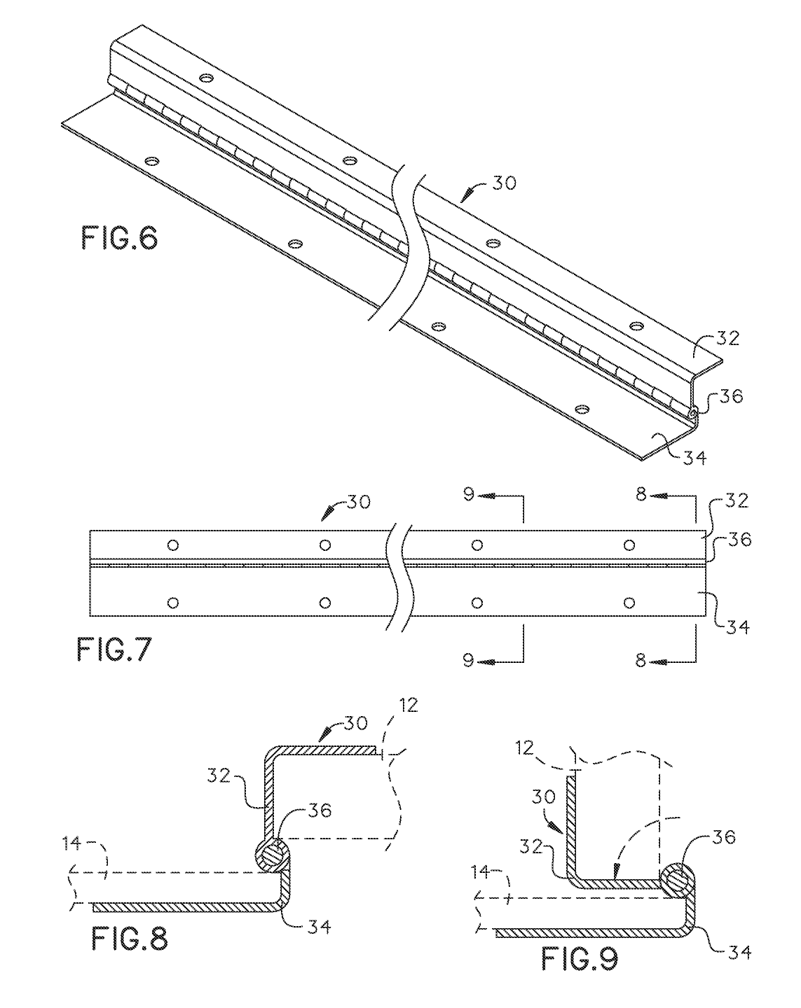

FIG. 6 and FIG. 7 show offset hinge 30. Offset hinge 30 comprises first portion 32 swingably coupled to second portion 34 with pin and knuckle connector 36. First portion 32 comprises a first parallel section immediately adjacent to a first perpendicular section. The first perpendicular section further comprises a knuckle connector first portion configured to accommodate a pin. Second portion 34 comprises a second parallel section immediately adjacent to a second perpendicular section. The second perpendicular section further comprises a knuckle connector second portion configured to accommodate the pin. The knuckle connector first portion and the knuckle connector second portion are joined with a pin to form pin and knuckle connector 36.

FIG. 8 and FIG. 9 show offset hinge 30 in more detail. Note that the first perpendicular section and the second perpendicular section can be parallel to one another (as in FIG. 8) or perpendicular to one another (as in FIG. 9), but they are in a non-collinear arrangement. Further, a line extended collinear to the first perpendicular section or the second perpendicular section would not pass through the center of the pin. This arrangement of having the perpendicular portions offset from both one another and the center of the pin makes hinge 30 an offset hinge. In some embodiments the second perpendicular section is longer than the first perpendicular section.

Returning to the use at hand, a user can mechanically couple the first parallel section to a top surface of side plate 12 while an edge of side plate 12 is immediately adjacent to the first perpendicular surface and pin and knuckle connector 36. A user can further mechanically couple the second parallel section to a bottom surface of bottom plate 14 while an edge of bottom plate 14 is immediately adjacent to the first perpendicular surface and pin and knuckle connector 36. This allows a user to rotate plate 12 parallel to upper plate 10 and bottom plate 14. At the same time, inner support plate 24 can be folded parallel to upper plate 10 and bottom plate 14 with piano hinge 18 causing the collapsed configuration shown in FIG. 2 and FIG. 5.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

That which is claimed:

1. An offset hinge, configured to arrange a side plate and a bottom plate; the offset hinge comprising:
a first portion swingably coupled to a second portion with a pin and knuckle connector;
wherein the first portion further comprises a first parallel section immediately adjacent to a first perpendicular section such that the first parallel section can be mechanically coupled to a top surface of the side plate which the first perpendicular section and the pin and knuckle connector further support the side plate and hold the side plate in place;
wherein the second portion further comprises a second parallel section immediately adjacent to a second perpendicular section such that the second parallel section can be mechanically coupled to a bottom surface of the bottom plate which the second perpendicular section and the pin and knuckle connector further support the bottom plate and hold the bottom plate in place;
wherein the first perpendicular section having a non-collinear arrangement with the second perpendicular section such that the first perpendicular section and the second perpendicular section are both offset from a center of the pin in the pin and knuckle connector.

2. The offset hinge of claim 1,
wherein the first perpendicular section further comprises a knuckle connector first portion;
wherein the second perpendicular section further comprises a knuckle connector second portion;
and the pin is inserted through the knuckle connector first portion and the knuckle connector second portion to form the pin and knuckle connector.

3. The offset hinge of claim 2, wherein the first perpendicular section is larger than the second perpendicular section to accommodate the side plate that is thicker than the bottom plate.
